(19) United States
(12) Patent Application Publication
(10) Pub. No.: US 2025/0072523 A1
(43) Pub. Date: Mar. 6, 2025

(54) SYSTEM COMPRISING AN AEROSOL PROVISION SYSTEM AND A WIRELESS BEACON

(71) Applicant: NICOVENTURES TRADING LIMITED, London (GB)

(72) Inventors: Connor BRUTON, London (GB); Timother BARKER, London (GB); Darryl BAKER, London (GB); Chaz NANDRA, London (GB); David RUSHFORTH, London (GB)

(21) Appl. No.: 18/725,858

(22) PCT Filed: Jan. 6, 2023
(86) PCT No.: PCT/GB2023/050023

§ 371 Date: Jul. 1, 2024

(30) Foreign Application Priority Data
Jan. 6, 2022 (GB) 2200126.7

(51) Int. Cl. A24F 40/65; A24F 40/60; H04W 4/021

(52) U.S. Cl. CPC A24F 40/65; A24F 40/60; H04W 4/021

(57) ABSTRACT

A non-combustible aerosol provision system comprises: a wireless communication system configured to receive, from a wireless communication beacon using a connectionless data channel, data relating to a physical location with which the beacon is associated; and a user interface system configured to communicate by a user interface element of the non-combustible aerosol provision system, an indication related to the received data.

### FIELD AND BACKGROUND

The present disclosure relates to, device to device sensing, and in particular but not exclusively to sharing of operational data between devices using a connectionless data channel.

A “non-combustible” aerosol provision system is an aerosol provision system where a constituent aerosol-generating material of the aerosol provision system (or component thereof) is not combusted or burned in order to facilitate delivery of at least one substance to a user.

The non-combustible aerosol provision system may be an electronic cigarette, also known as a vaping device or electronic nicotine delivery system (END), although it is noted that the presence of nicotine in the aerosol-generating material is not a requirement.

The non-combustible aerosol provision system may be an aerosol-generating material heating system, also known as a heat-not-burn system. An example of such a system is a tobacco heating system.

The non-combustible aerosol provision system may be a hybrid system to generate aerosol using a combination of aerosol-generating materials, one or a plurality of which may be heated. Each of the aerosol-generating materials may be, for example, in the form of a solid, liquid or gel and may or may not contain nicotine. The hybrid system may comprise a liquid or gel aerosol-generating material and a solid aerosol-generating material. The solid aerosol-generating material may comprise, for example, tobacco or a non-tobacco product.

Typically, the non-combustible aerosol provision system may comprise a non-combustible aerosol provision device and a consumable for use with the non-combustible aerosol provision device. The consumable may include aerosol-generating material from which the non-combustible aerosol provision device can generate an aerosol.

The non-combustible aerosol provision system, such as a non-combustible aerosol provision device thereof, may comprise a power source and a controller. The power source may, for example, be an electric power source or an exothermic power source. The exothermic power source comprises a carbon substrate which may be energised so as to distribute power in the form of heat to an aerosol-generating material or to a heat transfer material in proximity to the exothermic power source.

The non-combustible aerosol provision system may comprise an area for receiving the consumable, an aerosol generator, an aerosol generation area, a housing, a mouthpiece, a filter and/or an aerosol-modifying agent.

The consumable for use with the non-combustible aerosol provision device may comprise aerosol-generating material, an aerosol-generating material storage area, an aerosol-generating material transfer component, an aerosol generator, an aerosol generation area, a housing, a wrapper, a filter, a mouthpiece, and/or an aerosol-modifying agent.

In the use of non-combustible aerosol provision systems, there can be information gathered by the device relating to the status of that device. This information may be information that is useful to a user of a non-combustible aerosol provision system in relation to information such as content of the aerosol-generating material, battery charge level or information relating to remaining aerosol-generating material level such as a puff count and/or total puff duration value. In addition information such as error codes may be generated by the device. Further, there may be information useful to a user aiming to regulate his or her use of the non-combustible aerosol provision system. Such information may also be of use to some form of administrator entity, for example allowing logging of numbers and types of error occurrences. The inventors have devised approaches for accessing such information in an energy-efficient and non-intrusive manner.

Methods of transferring data using low power communications protocols such as Bluetooth™ or Bluetooth Low Energy (BTLE), also known as Bluetooth Smart, often involve establishing a partnership, bonding, pairing or other connection-based channel between two entities to facilitate transmitting information over that protocol.

### SUMMARY

Particular aspects are set out in the independent and dependent claims.

Viewed from a first aspect, there can be provided a non-combustible aerosol provision system comprising: a wireless communication system configured to receive, from a wireless communication beacon using a connectionless data channel, data relating to a physical location with which the beacon is associated; and a user interface system configured to communicate by a user interface element of the non-combustible aerosol provision system, an indication related to the received data.

Viewed from another aspect, there can be provided a wireless communication beacon comprising: a data interface configured to receive data relating to a physical location with which the beacon is associated; and a wireless communication system configured to transmit using a connectionless data channel, data relating to the physical location with which the beacon is associated.

Viewed from a further aspect, there can be provided a system comprising: a non-combustible aerosol provision system and a wireless beacon, the wireless beacon comprising: a data interface configured to receive data relating to a physical location with which the beacon is associated; and a wireless communication system configured to transmit using a connectionless data channel, data relating to the physical location with which the beacon is associated; and the non-combustible aerosol provision system comprising: a wireless communication system configured to receive, from the wireless communication beacon using a connectionless data channel, the data relating to the physical location with which the beacon is associated; and a user interface system configured to communicate by a user interface element of the non-combustible aerosol provision system, an indication related to the data relating to the physical location with which the beacon is associated.

Viewed from an additional aspect, there can be provided a method comprising: receiving, by a non-combustible aerosol provision system and from a wireless communication beacon using a connectionless data channel, data relating to a physical location with which the beacon is associated; and communicating by a user interface element of the non-combustible aerosol provision system, an indication related to the received data.

Viewed from another aspect, there can be provided a method for a wireless beacon comprising: receiving, via a data interface, data relating to a physical location with which the beacon is associated; and transmitting, using a wireless communication system configured to use a connectionless data channel, data relating to the physical location with which the beacon is associated.

Viewed from a further aspect, there can be provided a method for a system comprising a non-combustible aerosol provision system and a wireless beacon, the method comprising: receiving, using a data interface of the wireless beacon data relating to a physical location with which the beacon is associated; transmitting, using a wireless communication system configured to transmit using a connectionless data channel, data relating to the physical location with which the beacon is associated; receiving, using a wireless communication system configured to receive using the connectionless data channel, the data relating to the physical location with which the beacon is associated; and communicating, using a user interface system configured to communicate by a user interface element of the non-combustible aerosol provision system, an indication representative of the data relating to the physical location with which the beacon is associated.

Further, although the above examples, aspects and embodiments are implemented in the context of a user interface of the non-combustible aerosol provision system, the same techniques can also and/or alternatively be deployed in the context of a user interface of a device in a state of data connectivity with the non-combustible aerosol provision system. For example, the device may be a user device having a wired or wireless connection to the non-combustible aerosol provision system.

### BRIEF DESCRIPTION OF FIGURES

Embodiments of the present teachings will now be described, by way of example only, with reference to accompanying drawings, in which:

FIG. 1 is a schematic illustrating an example of a non-combustible aerosol provision system;

FIG. 2A schematically illustrates an approach for providing communication between multiple separate non-combustible aerosol provision systems;

FIG. 2B is a flowchart of an approach for providing communication between multiple separate non-combustible aerosol provision systems;

FIGS. 3A, 3B and 3C schematically illustrate another approach for providing communication between multiple separate non-combustible aerosol provision systems;

FIG. 3D is a flowchart of an approach for providing communication between multiple separate non-combustible aerosol provision systems;

FIG. 4A schematically illustrates an approach for providing communication between multiple separate non-combustible aerosol provision systems;

FIG. 4B is a flowchart of an approach for providing communication between multiple separate non-combustible aerosol provision systems;

FIG. 5A schematically illustrates an approach for providing communication between a non-combustible aerosol provision system and a beacon;

FIG. 5B is a flowchart of an approach for providing communication between a non-combustible aerosol provision system and a beacon;

FIG. 5C is a flowchart of an approach for providing communication between a non-combustible aerosol provision system and a beacon; and

FIG. 6a is a schematic illustration of a sequence of user interface screens.

FIG. 6b is a schematic illustration of a sequence of user interface screens.

While the presently described approach is susceptible to various modifications and alternative forms, specific embodiments are shown by way of example in the drawings and are herein described in detail. It should be understood, however, that drawings and detailed description thereto are not intended to limit the scope to the particular form disclosed, but on the contrary, the scope is to cover all modifications, equivalents and alternatives falling within the spirit and scope as defined by the appended claims.

### DETAILED DESCRIPTION

The present disclosure relates generally to sharing of information between different non-combustible aerosol provision system devices, with the information then being displayed on the non-combustible aerosol provision system itself. Both the sharing and the displaying take place without any sending of data to, from or via a connected device such as a smartphone.

The present disclosure also relates to the sharing of stock information from a beacon associated with a stock-holding location to a non-combustible aerosol provision system. The stock information is then displayed to a user directly by the non-combustible aerosol provision system.

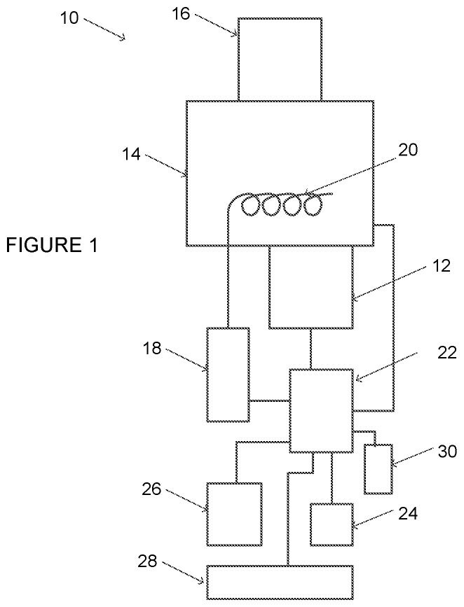

It will be appreciated that the present approaches involve transmission of data to and from a non-combustible aerosol provision system, and for the non-combustible aerosol provision system to process stored and/or received data. Therefore, to illustrate suitable devices for providing such functionalities, an example non-combustible aerosol provision system 10 is illustrated with respect to FIG. 1.

An example of a non-combustible aerosol provision system 10 is schematically illustrated in FIG. 1. As shown, the aerosol delivery device 10 is a device which contains elements relating to aerosol generation such as an aerosol-generating material container or cartridge 12 (in the case of an END device, the aerosol-generating material container or cartridge 12 will contain nicotine or a nicotine-bearing formulation), an aerosol generation chamber 14 and an outlet 16 through which a generated aerosol may be discharged. The aerosol-generating material container or cartridge 12 in general stores an aerosol-generating material (alternatively termed an aerosol medium) and may be or be a part of a consumable. A battery 18 may be provided which to power a thermal generator element (such as a heater coil 20) within (or functionally adjacent to) the aerosol generation chamber 14. The battery 18 may also power a processor/controller 22 which may serve purposes of device usage, such as activation of the device for aerosol generation in response to an activation trigger, and purposes of communication and functionality control. Processor/controller 22 may have access to a memory 24 which may be used to store operating instructions for the processor/controller 22. The memory 24 may also be used to store data describing operating conditions and/or states of the non-combustible aerosol provision system 10 and/or one or more components thereof. The memory 24 may be internal to the processor/controller 22 or may be provided as an addition separate physical element.

To perform transmission and reception of data and/or messaging, the processor/controller 22 is provided with a transmitter/receiver element 26. The transmitter/receiver element 26 enables the non-combustible aerosol provision system 10 to communicate with a connected device using a connectivity technology such as a personal area network protocol. Example personal area network protocols include Bluetooth™, Bluetooth Low Energy™ (BLE), Zigbee™, Wireless USB, and Near-Field Communication (NFC). Example personal area network protocols also include protocols making use of optical communication such as Infrared Data association (IrDA), and data-over-sound. Other wireless technologies such as a Wi-Fi™ technology may be used if the non-combustible aerosol provision system has suitable capability. In other examples, the transmitter/receiver element 26 may be configured to provide for a wired communication channel provided between physical ports of the non-combustible aerosol provision system 10 and a connected device. Such a wired communication channel may utilise a physical connection technology such as USB™, a serial port, FireWire™ or other point-to-point wired connectivity. The remainder of this discussion will use the example of BLE and will use BLE terminology, although it will be appreciated that corresponding or equivalent functionalities of other personal area network technologies may be substituted. Thus, in the present example, the transmitter/receiver element 26 is a BLE interface element including or connected to a radio antenna for wireless communication. In other examples such as those indicated above this may be an interface element for an alternative wireless technology and/or a wired connection interface.

Any communication established with a connected device may be impermanent or otherwise transient in the sense that the channel may be established for a period of time necessary to carry out specific functionalities, but may also be disconnected when not required. In the present examples, the connected device will typically be another non-combustible aerosol provision system. In some examples, the connected device may additionally or alternatively be some form of user device (which may also be termed a remote device, in the sense that the device is remote from the non-combustible aerosol provision system) such as a mobile telephone (cellphone) or tablet of a user (and/or owner) of the non-combustible aerosol provision system.

Continuing the discussion of FIG. 1, the processor/controller 22 may in one example be an STM32 microcontroller as provided by ST Microelectronics and based on the ARM™ Cortex™-M processor. In other examples an alternative microcontroller or processor may be used, which may be based upon an ARM™ architecture, and Atom™ architecture or other low power processor technology. Alternatively or additionally, the transmitter/receiver element 26 may in one example include an nRF BLE chip for cooperating with the processor/controller to provide BLE connectivity to the non-combustible aerosol provision system. In other examples, other communication interface chips or modules may be deployed to provide connectivity services.

As illustrated, processor/controller 22 may be connected for example to aerosol-generating material container or cartridge 12, aerosol generation chamber 14 and battery 18.

This connection may be to an interface connection or output from ones of the components and/or may be to a sensor located at or in ones of the components. These connections may provide access by the processor to properties of the respective components. For example a battery connection may be used to control activation of the non-combustible aerosol provision system for aerosol generation.

Further functionalities of the processor/controller 22 and/or the memory 24 will be described with reference to the examples of the present approaches below.

In addition, the non-combustible aerosol provision system includes an output element 28. This output element is capable of outputting a representation of/derived from data stored in the memory 24 and/or received by the transmitter/receiver element 26. In the present examples the output element includes a visual display element, such as an illuminable indicator (e.g. an LED, multicolour LED, or the like) or a display configured to output one or more letters, numerals or symbols. Where the output element 28 is a display, this may be a matrix or grid-type display such as an LED display, an LCD display or the like. In some examples, the output element 28 may additionally or alternatively include an audio output element. Such an audio output element may be configured to emit one or more sounds. In some examples, the output element 28 may additionally or alternatively include a haptic feedback element. Such a haptic feedback element may be configured to cause detectable vibration or buzzing of the non-combustible aerosol provision system.

The non-combustible aerosol provision system may also include an input element 30. In the present examples, this input element 30 includes a button or other element capable of receiving a physical input from a user. Where the output element 28 is a display, the input element may be a touch-sensitive and/or pressure-sensitive detector included in the display, such as a touch-screen display. In some examples, the input element 30 may also or alternatively include an audio detector capable of receiving an audio input. Such an audio input may then be subjected to recognition processing (such as speech recognition processing) by the controller/processor 22 (or other processing hardware of the non-combustible aerosol provision system) in order to receive an audio input from a user.

The output element 28 and input element 30 (where present) may be described as being, or being part of, a user interface system of the non-combustible aerosol provision system 10. Content to be communicated via the output element 28 is provided from the processor/controller 22 to the output element and inputs received via the input element 30 are provided to the processor/controller 22. Thus the processor/controller 22 and/or instructions operating thereon may also be described as being part of the user interface system. The user interface system provides a mechanism by which a user of the non-combustible aerosol provision system 10 can receive information/notifications from the non-combustible aerosol provision system 10, and optionally also a mechanism by which the user can provide inputs to the non-combustible aerosol provision system 10. Collectively the output element 28 and input element 30 may be termed user interface elements. In some examples, the non-combustible aerosol provision system may be activatable for aerosol generation by the input element 30 or by performing an act that causes detectable airflow through one or more aerosol-generation-related components of the non-combustible aerosol provision system. Thus the mechanism by which the non-combustible aerosol provision system is activate for aerosol generation may be considered as being a part or separate from the user interface system.

Although it is described above that the non-combustible aerosol provision system includes one or more user interface elements of a user interface system, the present teachings are also applicable to situations in which a connected device (for example connected in wired or wireless manner using the transmitter/receiver element) having its own user interface system. Such a connected device user interface may be used to implement and achieve any or all of the user interface behaviours described herein, which may be in addition to or instead of conduct of some or all of those user interface behaviours using the user interface system of the non-combustible aerosol provision system.

Thus there has been described a non-combustible aerosol provision system that may interact with one or more other non-combustible aerosol provision systems to provide a number of additional functionalities for the non-combustible aerosol provision system to a user of the non-combustible aerosol provision system. Examples of such functionalities will now be described.

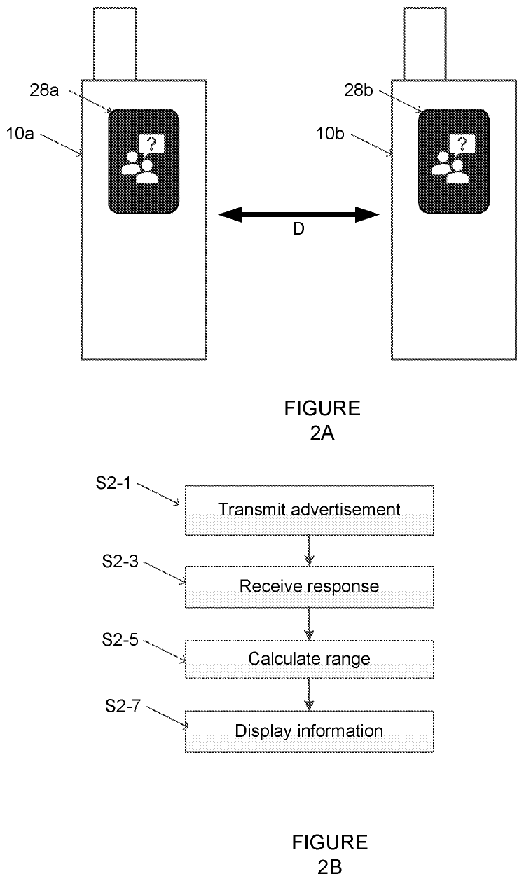

FIGS. 2A and 2B collectively illustrate a first approach for providing communication between multiple separate non-combustible aerosol provision systems.

This approach relates to a given non-combustible aerosol provision system being configured to provide an indication to a user that one or more other non-combustible aerosol provision systems are in proximity to the user's non-combustible aerosol provision system. In this example, as illustrated in FIG. 2A, two non-combustible aerosol provision systems 10a and 10b are within BLE communications distance D from one-another. Either or both non-combustible aerosol provision systems can perform an approach to determine whether the other non-combustible aerosol provision system is within range of another non-combustible aerosol provision system. In response to the separate determination at each non-combustible aerosol provision system that the other non-combustible aerosol provision system is within range, the respective display element 28 of each non-combustible aerosol provision system can display an indication that at least one other non-combustible aerosol provision system is active within range. Although FIG. 2A indicates that both non-combustible aerosol provision systems 10a and 10b have performed this method in order to each be able to display an indication that at least one other non-combustible aerosol provision system is within range, the present approaches are equally applicable if it happens that only one of two or more non-combustible aerosol provision systems that are mutually within range of each other performs the described approaches.

The method that can be independently performed by each non-combustible aerosol provision system to achieve this functionality is shown in FIG. 2B. Starting at step S2-1, the non-combustible aerosol provision system 10a transmits an advertising packet. This may be a standard BLE advertising packet of a type that is conventionally used to advertise the presence of a BLE device as being available for BLE connection/pairing. No particular advertising packet payload is required for the present approach. To provide for high levels of proximity information to be provided to a user of the non-combustible aerosol provision system, the non-combustible aerosol provision system may be configured to repeatedly send such advertising packets without user input at a suitable time interval. On the other hand, it may be appropriate to conserve battery power of the non-combustible aerosol provision system for aerosol generation or other functionalities, such that a user input may be used to trigger either the sending of the advertising packet or the activation of an operation mode in which such advertising packets are sent. Where a user input is required for this functionality, the non-combustible aerosol provision system will include an input element 30.

Responsive to receipt of the BLE advertising packet by the other non-combustible aerosol provision system 10b, that other non-combustible aerosol provision system 10b sends a response packet. The response packet may be either a BLE scan request packet or a BLE connection request packet. The response packet is then received at the non-combustible aerosol provision system 10a at step S2-3. From this fact that this response message has been received, the non-combustible aerosol provision system 10a already knows that the other non-combustible aerosol provision system 10b is within communication range. Were this not the case, then no response packet would have been received. Accordingly, the non-combustible aerosol provision system 10a knows that another non-combustible aerosol provision system which is an active state is present within the communication range.

Thus the non-combustible aerosol provision system 10a displays at step S2-7 some information using the display element 28a of the non-combustible aerosol provision system 10a to indicate to the user that another non-combustible aerosol provision system is within range. As shown in FIG. 2A this displayed information is in the present example a symbol indicative of some other non-combustible aerosol provision system being in range. In other examples this information could be provided by one or more of other symbols, one or more letters, one or more numerals, one or more audible indications and/or one or more haptic indications.

Although it is explained that the response packet may be a BLE scan packet or a BLE connection request packet (either or both of which may be used as part of a process of establishing a BLE pairing or connection), there is no need for a BLE pair/connection to be established to utilise the approaches of the present examples. In other words, the present approaches utilise a connectionless state of Bluetooth/BLE to achieve the described outcomes. It may be the case that such a pairing/connection is required/desired and thus this may optionally be proceeded with in addition to the present method. As mentioned above, while the present examples discuss Bluetooth/BLE terminology, the taught approaches can employ other connectivity technologies, such as other Personal Area Network technologies, to provide an exchange of connectionless and/or connection precursor packets. As will be recognised, a connectionless state packet is a packet transmitted without (or prior to completion of) a formal, bonding, pairing or other connection establishment process. Thus a connectionless channel is a channel over which connectionless state packets may be transmitted and/or received, i.e. a channel for exchange of packets and for which no a formal, bonding, pairing or other connection establishment process has been completed.

Optionally, the non-combustible aerosol provision system 10a may perform an additional step to determine a range to the other non-combustible aerosol provision system 10b from which the response was received at step S2-3. This determination, as shown at optional step S2-5, includes calculating a range to the device from which the response packet was received (in this example that device being the other non-combustible aerosol provision system 10b). This range calculation may be based upon a received signal power of the response packet. By knowing the received signal power an approximate value of the distance D can be calculated. Thus the display of information at step S2-7 can be performed to indicate when another non-combustible aerosol provision system is within the distance D corresponding to the threshold.

In the present example, the distance calculation is a threshold distance calculation. In other words, the calculation determines that the received signal power of the response packet is either greater or lower than a pre-set threshold. This threshold is pre-set in the non-combustible aerosol provision system 10a as being representative of a given value of the distance D. Thus in one particular example, the threshold may be set so as to determine when another non-combustible aerosol provision system 10 comes within 10 m of the non-combustible aerosol provision system 10a. Other range values are possible, and the non-combustible aerosol provision system 10a may have multiple different range thresholds that a user can choose between for “in-range” detection purposes.

To set the thresholds for use by a non-combustible aerosol provision system a calculation may be performed based on an assumed and/or expected average transmit power of all non-combustible aerosol provision systems 10 compatible with the present approaches, and an assumed power drop over distance in expected transmission media (likely air, although an allowance may be made for some degree of intervening building structures and/or biological bodies and/or for signal interference). As will be understood, the determining of a range using such a threshold based upon such assumed parameters is necessarily approximate, as factors such as an unexpectedly high or low response packet transmit power, higher or lower amounts of intervening building structures or biological bodies, and higher or lower levels interference in the transmit frequency band(s) may all affect the received signal power. As such, a threshold representative of a particular distance D will necessarily encompass a range of possible distances with a probability that the distance between two non-combustible aerosol provision system 10 is approximately the particular distance D.

By using a threshold-based calculation as explained above, the individual non-combustible aerosol provision system 10a can calculate a distance using a simple calculation that does not require large amounts of processing power. As such the present approach may be implemented in a non-combustible aerosol provision system 10 having a low powered controller/processor 22.

In other examples, and by accepting that the non-combustible aerosol provision system 10a will need to perform a more complex calculation, the non-combustible aerosol provision system 10a may calculate an actual (albeit approximate) range to the other non-combustible aerosol provision system 10b from which the response packet was received. In this example, the non-combustible aerosol provision system 10a will use an actual or likely transmit power for that kind of received packet. This may be included as an assumed value within programming of the non-combustible aerosol provision system 10a or may be included as payload data in the received response packet. The non-combustible aerosol provision system 10a will also use a value or equation indicative of expected signal strength drop with distance. By knowing the received signal power of the response packet and these two addition pieces of information, the non-combustible aerosol provision system 10a may calculate an actual range to the other non-combustible aerosol provision system 10b. This actual range will be subject to uncertainty in the same way as explained above in relation to the threshold approach. Using this approach, the non-combustible aerosol provision system 10a may include in the display information a representation of the distance.

Although the above discussion refers to providing an indication of another non-combustible aerosol provision system being in range of a user's non-combustible aerosol provision system, the same approach may be used to determine such a range condition in respect of multiple other non-combustible aerosol provision systems. The same method would be carried out by the user's non-combustible aerosol provision system in respect of each other non-combustible aerosol provision system (noting that a single advertising packet may elicit a response from more than one other non-combustible aerosol provision system, or separate advertising packets may each elicit a response from different other non-combustible aerosol provision systems). The display information may then for example indicate a number of other non-combustible aerosol provision systems within range. Additionally or alternatively the non-combustible aerosol provision system may provide for use of the input element 30 to cause information about each detected non-combustible aerosol provision system to be displayed in turn.

Although the above discussion is described from the perspective of non-combustible aerosol provision system 10a, the same is applicable where the method is performed by non-combustible aerosol provision system 10b, although in this case it is the other non-combustible aerosol provision system 10b which sends the advertisement and the non-combustible aerosol provision system 10a which provides the response.

Thus there has been described an approach by which a non-combustible aerosol provision system can determine when at least one other non-combustible aerosol provision system is within a certain range (such as a communication range, a predetermined distance and/or a calculated distance) and display information describing the situation to a user of the non-combustible aerosol provision system by the non-combustible aerosol provision system itself. In other words, this approach provides for a user of an non-combustible aerosol provision system to be informed when another non-combustible aerosol provision system comes within range. This may permit or encourage exchange of information and/or assistance as between different users of the two non-combustible aerosol provision systems.

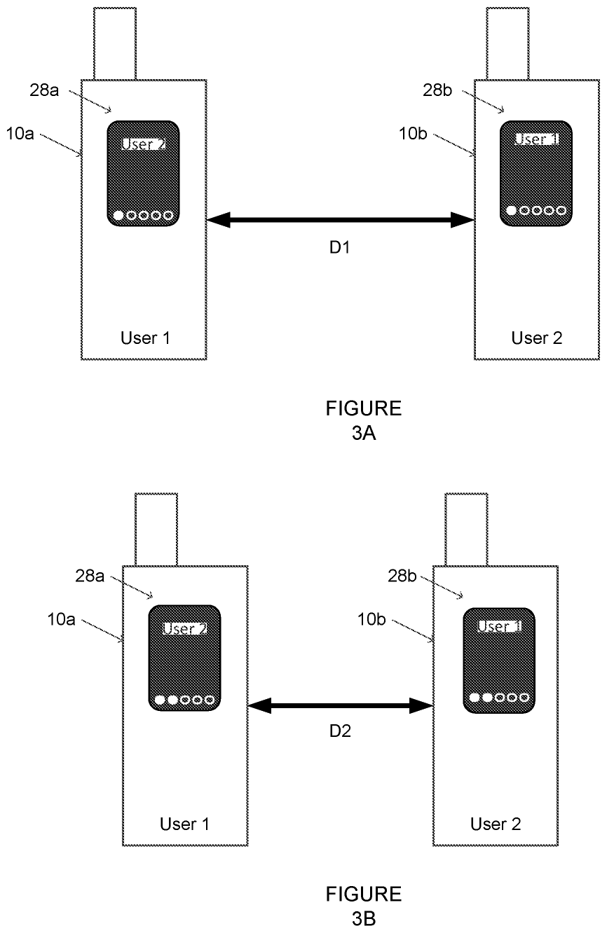

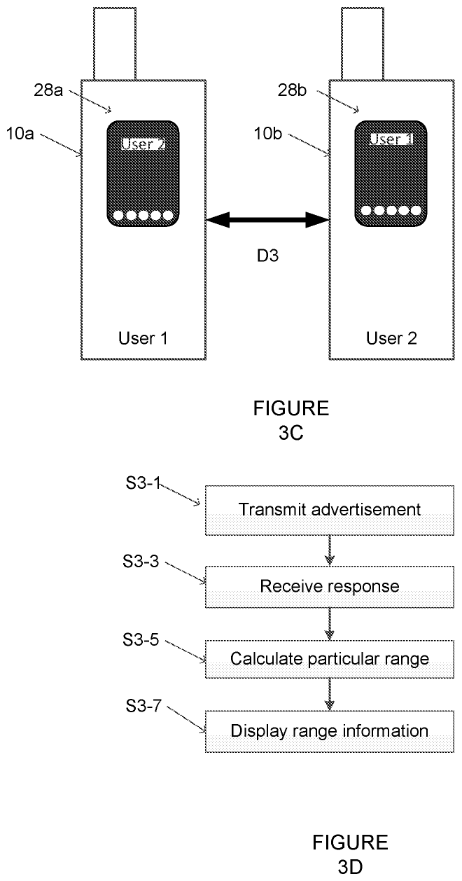

FIGS. 3A, 3B, 3C and 3D collectively illustrate another approach for providing communication between multiple separate non-combustible aerosol provision systems.

The present approach is similar to the approach illustrated with respect to FIGS. 2A and 2B, however in this approach the non-combustible aerosol provision system 10a is configured to indicate a degree of proximity to one or more other active non-combustible aerosol provision systems.

In this example, as illustrated in FIG. 3A, two non-combustible aerosol provision systems 10a and 10b are within a distance D1 from one-another. In the present examples the distance D1 is a relatively long distance, perhaps at or near the maximum communication range of the non-combustible aerosol provision systems. Thus the display 28a of non-combustible aerosol provision system 10a indicates another non-combustible aerosol provision system at a long distance and in the present example also indicates an identifier of other non-combustible aerosol provision system. This identifier may be information included in a response packet received from the other non-combustible aerosol provision system, or may be an arbitrary identifier assigned by the non-combustible aerosol provision system which is displaying the proximity information. Where the identifier was included in a response packet received from the other non-combustible aerosol provision system, the identifier may be an actual identifier of the user or device, or may be a nickname or other non-personally identifying identifier. Where an identifier if any type is provided in a response packet, this identifier may in some examples only be included in the response packet where a user of the non-combustible aerosol provision system has provided permission for such identifier sharing.

In the illustrated example, the display 28a of the non-combustible aerosol provision system 10a displays an identifier “user 2” along with the distance indicator, the identifier “user 2” being used to indicate that the other non-combustible aerosol provision system is identified as or assumed to be associated with a user different to the user of non-combustible aerosol provision system 10a, who is given the identifier “user 1” in the present example. The display 28b of the non-combustible aerosol provision system 10b correspondingly has performed the same approach and thus displays a similar range indicator but an identifier assigned to or received from the other non-combustible aerosol provision system 10a, in this example the received or applied identifier “user 1”.

As then illustrated in FIG. 3B, the two non-combustible aerosol provision system 10a and 10b are separated by a distance D2, which is less than distance D1. Accordingly, the display 28 of each non-combustible aerosol provision system now indicates the same identifier information as in FIG. 3A, but the distance indicator is now representative of the reduced distance (or greater proximity) between the two non-combustible aerosol provision systems.

As then further illustrate in FIG. 3C, the two non-combustible aerosol provision system 10a and 10b are separated by a distance D3, which is less than distance D1 and distance D2. Accordingly, the display 28 of each non-combustible aerosol provision system now indicates the same identifier information as in FIGS. 3A and 3B, but the distance indicator is now representative of the further reduced distance (or even greater proximity) between the two non-combustible aerosol provision systems.

As with the approaches discussed above with reference to FIGS. 2A and 2B, the illustration in FIGS. 3A, 3B and 3C indicates display elements 28 of each non-combustible aerosol provision system having performed the method of the present approach, but again the present disclosure encompasses this method being performed by only one (or otherwise less than all) of the non-combustible aerosol provision systems.

Accordingly, a given non-combustible aerosol provision system can provide a display of a degree of proximity of one or more other non-combustible aerosol provision systems. The method that can be independently performed by each non-combustible aerosol provision system to achieve this functionality is now further described with reference to FIG. 3D.

Starting at step S3-1, the non-combustible aerosol provision system 10a transmits an advertising packet. This may be a standard BLE advertising packet of a type that is conventionally used to advertise the presence of a BLE device as being available for BLE connection/pairing. No particular advertising packet payload is required for the present approach. To provide for high levels of proximity information to be provided to a user of the non-combustible aerosol provision system, the non-combustible aerosol provision system may be configured to repeatedly send such advertising packets without user input at a suitable time interval. On the other hand, it may be appropriate to conserve battery power of the non-combustible aerosol provision system for aerosol generation or other functionalities, such that a user input may be used to trigger either the sending of the advertising packet or the activation of an operation mode in which such advertising packets are sent. Where a user input is required for this functionality, the non-combustible aerosol provision system will include an input element 30.

Responsive to receipt of the BLE advertising packet by the other non-combustible aerosol provision system 10b, that other non-combustible aerosol provision system 10b sends a response packet. The response packet may be either a BLE scan request packet or a BLE connection request packet. The response packet is then received at the non-combustible aerosol provision system 10a at step S3-3. The response packet thus again indicates to the non-combustible aerosol provision system 10a that another non-combustible aerosol provision system is in an active state and within communications range.

Although it is explained that the response packet may be a BLE scan packet or a BLE connection request packet (either or both of which may be used as part of a process of establishing a BLE pairing or connection), there is no need for a BLE pair/connection to be established to utilise the approaches of the present examples. In other words, the present approaches utilise a connectionless state of Bluetooth/BLE to achieve the described outcomes. It may be the case that such a pairing/connection is required/desired and thus this may optionally be proceeded with in addition to the present method.

After receipt of the response packet at step S2-3, the non-combustible aerosol provision system 10a determines of a particular range to the other non-combustible aerosol provision system 10b. This determination, as shown at optional step S3-5, includes calculating a range to the device from which the response packet was received (in this example that device being the other non-combustible aerosol provision system 10b). Much as described with respect to FIGS. 2A and 2B, this range calculation may be based upon a received signal power of the response packet. By knowing the received signal power an approximate value of the distance D can be calculated. Thus the non-combustible aerosol provision system 10a displays at step S3-7 some information using the display element 28a of the non-combustible aerosol provision system 10a to indicate to the user that another non-combustible aerosol provision system is within range. As shown in FIGS. 3A, 3B and 3C this displayed information is in the present example an identifier indicative of the other non-combustible aerosol provision system 10b and an indication of the degree of proximity (or range distance) to the non-combustible aerosol provision system. In other examples this information could be provided by one or more of other symbols, one or more letters, one or more numerals, one or more audible indications and/or one or more haptic indications.

In the present example, the distance calculation is a threshold distance calculation. In other words, the calculation determines that the received signal power of the response packet is either greater or lower than each of two or more pre-set thresholds. Each threshold is pre-set in the non-combustible aerosol provision system 10a as being representative of a given value of the distance. Thus, in the present example where three ranges are possible, the received signal power is compared against each of three thresholds, one threshold corresponding to the longest distance D1, a second threshold corresponding to the middle distance D2, and a third threshold corresponding to the shortest distance D3. Thus in one particular example, the thresholds may be set so as to determine when another non-combustible aerosol provision system 10 is present within 10 m of the non-combustible aerosol provision system 10a, within 8 m of the non-combustible aerosol provision system 10a, and 2 m of the non-combustible aerosol provision system 10a. In other examples, other range values and/or a greater or smaller number of thresholds may be implemented. In one specific example, two range thresholds are used, and these may correspond for example to ranges of 10 m and 4 m.

Each such threshold may be set in the same way as the threshold already described with reference to FIGS. 2A and 2B above. Thus the ranges may be expected to be somewhat approximate or indicative of a probability in the same way.

As discussed above, from the fact that this response message has been received, the non-combustible aerosol provision system 10a already knows that the other non-combustible aerosol provision system 10b is within communication range. Were this not the case, then no response packet would have been received. Thus, in some examples, this fact may be used as indicative of the other non-combustible aerosol provision system 10b being within a first (longest) range D1 such that no threshold test is required to establish that the other non-combustible aerosol provision system 10b is within the longest range D1. One or more additional ranges may then be determined using the threshold approach. Accordingly, in an example in which only two ranges are represented, the presence of the other non-combustible aerosol provision system within the longer of the two ranges is determined by the reception of the response packet and the presence of the other non-combustible aerosol provision system within the shorter of the two ranges is determined by testing against a threshold representative of that shorter range.

By using a threshold-based calculation as explained above, the individual non-combustible aerosol provision system 10a can calculate a distance using a simple calculation that does not require large amounts of processing power. As such the present approach may be implemented in a non-combustible aerosol provision system 10 having a low powered controller/processor 22.

In other examples, and by accepting that the non-combustible aerosol provision system 10a will need to perform a more complex calculation, the non-combustible aerosol provision system 10a may calculate an actual (albeit approximate) range to the other non-combustible aerosol provision system 10b from which the response packet was received. In this example, the non-combustible aerosol provision system 10a will use an actual or likely transmit power for that kind of received packet. This may be included as an assumed value within programming of the non-combustible aerosol provision system 10a or may be included as payload data in the received response packet. The non-combustible aerosol provision system 10a will also use a value or equation indicative of expected signal strength drop with distance. By knowing the received signal power of the response packet and these two addition pieces of information, the non-combustible aerosol provision system 10a may calculate an actual range to the other non-combustible aerosol provision system 10b. This actual range may then be included in the display 18a, either as a symbolic range relative to detectable maxima and minima or as a numerical actual range.

Although the above discussion refers to providing an indication of another non-combustible aerosol provision system being in range of a user's non-combustible aerosol provision system, the same approach may be used to determine such a range condition in respect of multiple other non-combustible aerosol provision systems. The same method would be carried out by the user's non-combustible aerosol provision system in respect of each other non-combustible aerosol provision system (noting that a single advertising packet may elicit a response from more than one other non-combustible aerosol provision system, or separate advertising packets may each elicit a response from different other non-combustible aerosol provision systems). The display information may then for example indicate a number of other non-combustible aerosol provision systems within each range. Additionally or alternatively the non-combustible aerosol provision system may provide for use of the input element 30 to cause information about the number if non-combustible aerosol provision systems detected within each range bracket and/or to provide for information about the range to each detected non-combustible aerosol provision system to be displayed in turn.

Although the above discussion is described from the perspective of non-combustible aerosol provision system 10a, the same is applicable where the method is performed by non-combustible aerosol provision system 10b, although in this case it is the other non-combustible aerosol provision system 10b which sends the advertisement and the non-combustible aerosol provision system 10a which provides the response.

Thus there has been described an approach by which a non-combustible aerosol provision system can determine when at least one other non-combustible aerosol provision system is within one or more ranges (or one or more degrees of proximity) and display information describing the situation to a user of the non-combustible aerosol provision system by the non-combustible aerosol provision system itself. In other words, this approach provides for a user of a non-combustible aerosol provision system to be informed when another non-combustible aerosol provision system is present within a certain range. This may permit or encourage exchange of information and/or assistance as between different users of the two non-combustible aerosol provision systems.

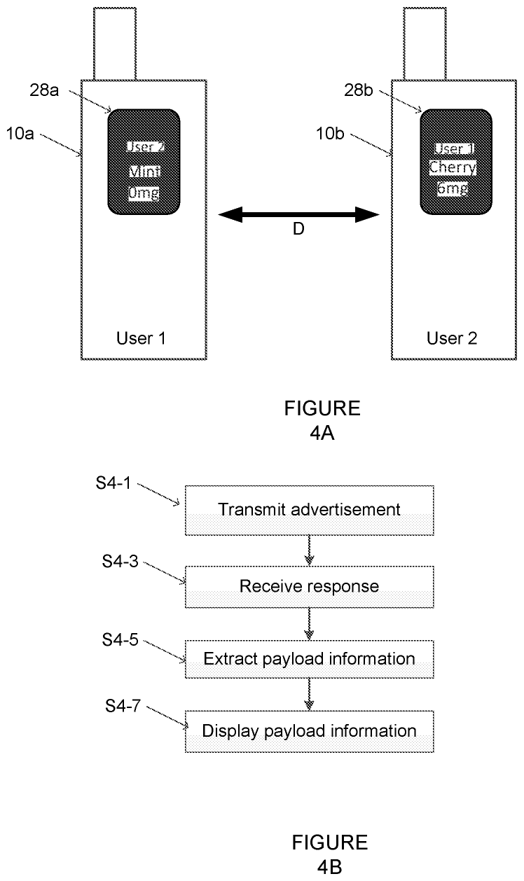

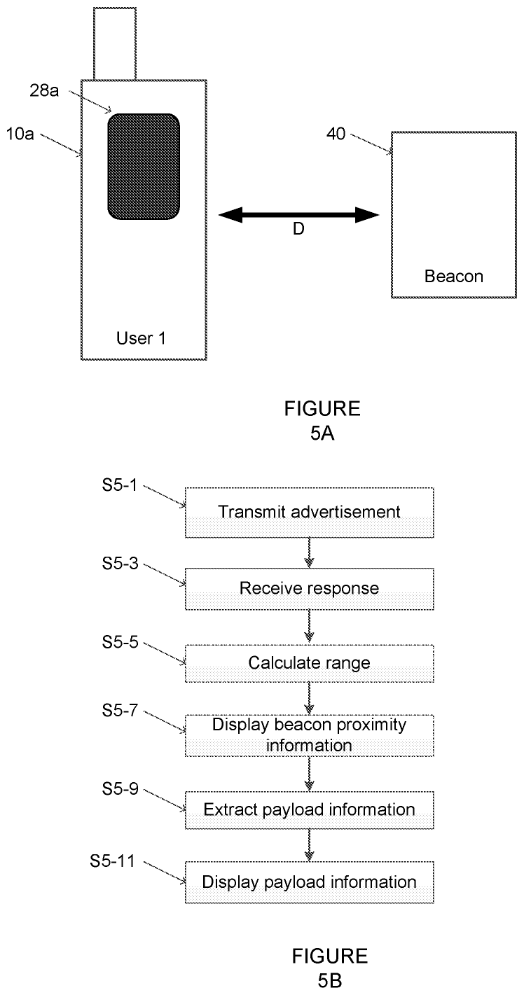

FIGS. 4A and 4B collectively illustrate another approach for providing communication between multiple separate non-combustible aerosol provision systems.

The present approach is similar to the approach illustrated with respect to FIGS. 2A and 2B (and may optionally be used in combination with either the approach illustrated with respect to FIGS. 2A and 2B or the approach illustrated with respect to FIGS. 3A, 3B, 3C and 3D) but in this case payload information included in the response packet is used to provide further information to the user of the non-combustible aerosol provision system.

In this example, as illustrated in FIG. 4A, two non-combustible aerosol provision systems 10a and 10b are within a communications distance D from one-another. Either or both non-combustible aerosol provision systems can perform an approach to determine whether the other non-combustible aerosol provision system is within range of another active non-combustible aerosol provision system and also determine some further operational information about the other. In response to the separate determination at each non-combustible aerosol provision system that the other non-combustible aerosol provision system is within active and range, as well as obtaining the further operational information, the respective display element 28 of each non-combustible aerosol provision system can display an indication that at least one other active non-combustible aerosol provision system is within range and display the further operational information about that other non-combustible aerosol provision system. Although FIG. 4A indicates that both non-combustible aerosol provision systems 10a and 10b have performed this method in order to each be able to display such information, the present approaches are equally applicable if it happens that only one of two or more non-combustible aerosol provision systems that are mutually within range of each other performs the described approaches.

In this example the further operational information (which is described as “further” in the sense that it is further to the operational information that the other non-combustible aerosol provision system is active) includes information about an aerosol-generating material in use in the non-combustible aerosol provision system. The aerosol-generating material may for example be contained within the aerosol-generating material container or cartridge 12. Information about the aerosol-generating material may be stored in the memory 24. In the present example, the aerosol-generating material container or cartridge 12 is a removable/replaceable element, and information describing the aerosol-generating material within the aerosol-generating material container or cartridge 12 may be detectable by the controller/processor 22. In other examples, the aerosol-generating material container or cartridge 12 may be a refillable container or cartridge and the user may be able to provide information on the aerosol-generating material to the non-combustible aerosol provision system directly or via a connected smartphone or tablet. In other examples the aerosol-generating material container or cartridge 12 may be a non-replaceable element such that the information about the aerosol-generating material may be stored into the non-combustible aerosol provision system as part of a manufacturing process.

The information about the aerosol-generating material may include information about a flavour or flavourant of the aerosol-generating material. As used herein, the terms “flavour” and “flavourant” refer to materials which, where local regulations permit, may be used to create a desired taste, aroma or other somatosensorial sensation in a product for adult consumers. They may include naturally occurring flavour materials, botanicals, extracts of botanicals, synthetically obtained materials, or combinations thereof (e.g., tobacco, cannabis, licorice (liquorice), hydrangea, eugenol, Japanese white bark magnolia leaf, chamomile, fenugreek, clove, maple, matcha, menthol, Japanese mint, aniseed (anise), cinnamon, turmeric, Indian spices, Asian spices, herb, wintergreen, cherry, berry, red berry, cranberry, peach, apple, orange, mango, clementine, lemon, lime, tropical fruit, papaya, rhubarb, grape, durian, dragon fruit, cucumber, blueberry, mulberry, citrus fruits, Drambuie, bourbon, scotch, whiskey, gin, tequila, rum, spearmint, peppermint, lavender, aloe vera, cardamom, celery, cascarilla, nutmeg, sandalwood, bergamot, geranium, khat, naswar, betel, shisha, pine, honey essence, rose oil, vanilla, lemon oil, orange oil, orange blossom, cherry blossom, cassia, caraway, cognac, jasmine, ylang-ylang, sage, fennel, wasabi, piment, ginger, coriander, coffee, hemp, a mint oil from any species of the genus Mentha, eucalyptus, star anise, cocoa, lemongrass, rooibos, flax, Ginkgo biloba, hazel, hibiscus, laurel, mate, orange skin, rose, tea such as green tea or black tea, thyme, juniper, elderflower, basil, bay leaves, cumin, oregano, paprika, rosemary, saffron, lemon peel, mint, beefsteak plant, curcuma, cilantro, myrtle, cassis, valerian, pimento, mace, damien, marjoram, olive, lemon balm, lemon basil, chive, carvi, verbena, tarragon, limonene, thymol, camphene), flavour enhancers, bitterness receptor site blockers, sensorial receptor site activators or stimulators, sugars and/or sugar substitutes (e.g., sucralose, acesulfame potassium, aspartame, saccharine, cyclamates, lactose, sucrose, glucose, fructose, sorbitol, or mannitol), and other additives such as charcoal, chlorophyll, minerals, botanicals, or breath freshening agents. They may be imitation, synthetic or natural ingredients or blends thereof. They may be in any suitable form, for example, liquid such as an oil, solid such as a powder, or gas.

In some examples, the flavour comprises menthol, spearmint and/or peppermint. In some embodiments, the flavour comprises flavour components of cucumber, blueberry, citrus fruits and/or redberry. In some embodiments, the flavour comprises eugenol. In some embodiments, the flavour comprises flavour components extracted from tobacco. In some embodiments, the flavour comprises flavour components extracted from cannabis.

In some examples, the flavour may comprise a sensate, which is intended to achieve a somatosensorial sensation which are usually chemically induced and perceived by the stimulation of the fifth cranial nerve (trigeminal nerve), in addition to or in place of aroma or taste nerves, and these may include agents providing heating, cooling, tingling, numbing effect. A suitable heat effect agent may be, but is not limited to, vanillyl ethyl ether and a suitable cooling agent may be, but not limited to eucolyptol, WS-3.

The information about the aerosol-generating material may also or alternatively include information about an active substance of the aerosol-generating material. The active substance as used herein may be a physiologically active material, which is a material intended to achieve or enhance a physiological response. The active substance may for example be selected from nutraceuticals, nootropics, psychoactives. The active substance may be naturally occurring or synthetically obtained. The active substance may comprise for example nicotine, caffeine, taurine, theine, vitamins such as B6 or B12 or C, melatonin, cannabinoids, or constituents, derivatives, or combinations thereof. The active substance may comprise one or more constituents, derivatives or extracts of tobacco, cannabis or another botanical.

In some examples, the active substance comprises nicotine. In some embodiments, the active substance comprises caffeine, melatonin or vitamin B12.

As illustrated in FIG. 4A, in the present example the information about the aerosol-generating material includes information about a flavour and information about a nicotine strength of the aerosol-generating material. As illustrated, the non-combustible aerosol provision system 10a of user 1 has aerosol-generating material with a cherry flavour and a nicotine strength of 6 mg per millilitre, and the non-combustible aerosol provision system 10b of user 2 has aerosol-generating material with a mint flavour and no nicotine content. It will be understood that these two specific illustrations of aerosol-generating material content are provided by way of example only and the present teachings encompass a wide range of possible aerosol-generating material content including but not limited to one or more of the flavours and/or one or more of the active substances mentioned above. As also discussed above, the user identifiers may be assigned/determined in a number of different ways and/or may be personally identifying or non-personally identifying in nature.

The information about the aerosol-generating material may be considered as being information about the aerosol-generating material container or cartridge 12, and thus may also be considered as being information about a consumable. Such a consumable may be referred to as an SKU or may be referred to or identified using an SKU identifier.

Other forms of further operational information may additionally or alternatively be used. These could include a remaining quantity of aerosol generating material (either in absolute terms or relative terms) and/or a remaining batter charge level (again either in absolute terms or relative terms).

The further operational information for a user's non-combustible aerosol provision system may in some examples only be provided by the non-combustible aerosol provision system after the user has given permission for such data to be shared.

Accordingly, a given non-combustible aerosol provision system can provide a display of a degree of proximity of one or more other non-combustible aerosol provision systems. The method that can be independently performed by each non-combustible aerosol provision system to achieve this functionality is now further described with reference to FIG. 4B.

Starting at step S4-1, the non-combustible aerosol provision system 10a transmits an advertising packet. This may be a standard BLE advertising packet of a type that is conventionally used to advertise the presence of a BLE device as being available for BLE connection/pairing. No particular advertising packet payload is required for the present approach. To provide for high levels of information about other nearby non-combustible aerosol provision systems to be provided to a user of the non-combustible aerosol provision system, the non-combustible aerosol provision system may be configured to repeatedly send such advertising packets without user input at a suitable time interval. On the other hand, it may be appropriate to conserve battery power of the non-combustible aerosol provision system for aerosol generation or other functionalities, such that a user input may be used to trigger either the sending of the advertising packet or the activation of an operation mode in which such advertising packets are sent. Where a user input is required for this functionality, the non-combustible aerosol provision system will include an input element 30.

Responsive to receipt of the BLE advertising packet by the other non-combustible aerosol provision system 10b, that other non-combustible aerosol provision system 10b sends a response packet. The response packet may be either a BLE scan request packet or a BLE connection request packet. The response packet is then received at the non-combustible aerosol provision system 10a at step S4-3. The response packet thus again indicates to the non-combustible aerosol provision system 10a that another non-combustible aerosol provision system is in an active state and within communications range. The response packet of this example includes the further operational information. This further operational information may therefore be included as part of a payload space in the response packet.

Although it is explained that the response packet may be a BLE scan packet or a BLE connection request packet (either or both of which may be used as part of a process of establishing a BLE pairing or connection), there is no need for a BLE pair/connection to actually be established to utilise the approaches of the present examples. In other words, the present approaches utilise a connectionless state of Bluetooth/BLE to achieve the described outcomes.

It may be the case that such a pairing/connection is required/desired and thus this may optionally be proceeded with in addition to the present method.

In some examples, it may be that multiple packets are needed to convey the further operational information due to the further operational information being larger than the available payload space of the response packet. In the present examples where the communications occur using BLE, this situation is accommodated by the use of a first response packet in the form of a BLE scan packet, responsive to the receipt of the BLE scan packet the non-combustible aerosol provision system sends a scan response packet to trigger a connection request packet from the other non-combustible aerosol provision system. In this way, the payload space of both the scan request packet and the connection request packet may be utilised to convey the further operational information without causing a pair/connection status to be established.

After receipt of the response packet at step S4-3, the non-combustible aerosol provision system 10a extracts payload information from the response packet to obtain the further operational information. Thus the non-combustible aerosol provision system 10a displays at step S4-7 the further operational information using the display element 28a of the non-combustible aerosol provision system 10a. As shown in FIG. 4A this displayed information is in the present example an identifier indicative of the other non-combustible aerosol provision system 10b and an indication of the flavour and nicotine strength in use by the the non-combustible aerosol provision system 10b. In other examples this information could be provided by one or more of other symbols, one or more letters, one or more numerals, one or more audible indications and/or one or more haptic indications.

Although the above discussion is described from the perspective of non-combustible aerosol provision system 10a, the same is applicable where the method is performed by non-combustible aerosol provision system 10b, although in this case it is the other non-combustible aerosol provision system 10b which sends the advertisement and the non-combustible aerosol provision system 10a which provides the response.

Thus there has been described an approach by which a non-combustible aerosol provision system can determine from at least one other non-combustible aerosol provision system within communication ranges operational information about the other non-combustible aerosol provision system, and display information describing that operational information to a user of the non-combustible aerosol provision system by the non-combustible aerosol provision system itself. In other words, this approach provides for a user of a non-combustible aerosol provision system to be informed by their non-combustible aerosol provision system operational properties of another non-combustible aerosol provision system within communication range. This may permit or encourage exchange of information and/or assistance as between different users of the two non-combustible aerosol provision systems.

Although the approach illustrated in FIGS. 2A & 2B, and the approach illustrated in FIGS. 3A, 3B, 3C & 3D have been described separately from the approach illustrated in FIGS. 4A and 4B, these approaches can be used in combination. Thus, for example, an implementation can be created in which a user's non-combustible aerosol provision system is able to display information about both range (whether a single range or one of a number of ranges) to another active non-combustible aerosol provision system as well as further operational information about that other non-combustible aerosol provision system.

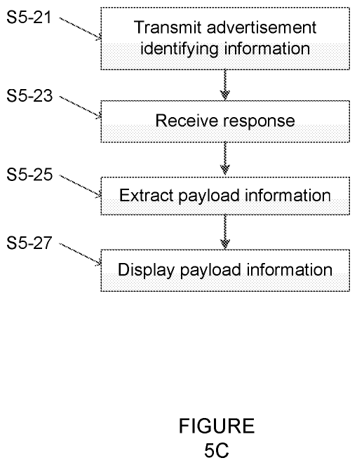

Additionally or alternatively, a non-combustible aerosol provision system can provide a display of a degree of proximity of an entity other than another non-combustible aerosol provision system. For example, the non-combustible aerosol provision system may be configured to provide distance to (and/or other information provided by) a beacon. Such a beacon may be deployed in geographic association with a facility such as a vendor location from which supplies for the non-combustible aerosol provision system may be available. Such a vendor location may include a battery recharge facility and/or an aerosol-generating material container or cartridge refill facility, and/or may retail supplies such as replacement batteries and/or aerosol-generating material container or cartridge. FIGS. 5A and 5B collectively illustrate an approach for providing communication between a beacon and a non-combustible aerosol provision systems. Such a beacon may have a data interface that links the beacon to a stock information data record (such as a stock list, one or more records of a stock database, or the like) via which the beacon can receive the stock information. Such stock information may be retrieved by the beacon in real time (i.e. in response to any particular request from a non-combustible aerosol provision system) and/or may be cached in a memory of the beacon (in which case a periodic refresh of the stock information cache may be implemented).

The present approach is similar to the approach illustrated with respect to FIGS. 2, 3 and 4, (and indeed a non-combustible aerosol provision system may be configured to perform the method of any of FIGS. 2 to 4 as well as the method of FIGS. 5A and 5B) but in this case communication is with a beacon and payload information included in the response packet from the beacon is used to provide distance and/or information about a facility or premises associated with the beacon.

In this example, as illustrated in FIG. 5A, non-combustible aerosol provision system 10a is within a communications distance D from a beacon 40. The non-combustible aerosol provision system 10a can perform an approach to determine whether the other non-combustible aerosol provision system is within range of a beacon 40 and/or determine some information provided by the beacon 40. In response to the determination at the non-combustible aerosol provision system that the beacon is within active and range, the display element 28a of the non-combustible aerosol provision system 10a can display an indication that the beacon is within range. As illustrated, the display element can display a logo or symbol indicative of the nearby presence of a beacon for a premises or facility. In some examples, the nature of the displayed symbol or logo may be used to indicate information about the nature of the premises or facility with which the beacon is associated, based upon further information conveyed from the beacon to the non-combustible aerosol provision system.

Alternatively, or in addition, once the non-combustible aerosol provision system has obtained the further information, the display element 28a of the non-combustible aerosol provision system can display information about the premises or facility with which the beacon is associated and based upon the further information received by the non-combustible aerosol provision system.

In this example the further information (which is described as “further” in the sense that it is further to the information that the beacon is active, which is inherently conveyed by the fact of a reply being received from the beacon) includes information about a premises or facility with which the beacon is associated. In the present examples, such a beacon is associated with the facility or premises both in terms of the content of the further information and geographically (i.e. that the beacon is in, on or near the premises or facility so that receipt of the beacon signal is indicative of proximity of the non-combustible aerosol provision system to the actual premises or facility. The content of further information provided by the beacon may include information about products and/or services available at the premises or facility. Such products and/or services may include for example in indication of one or more of a battery recharge facility, an aerosol-generating material container or cartridge refill facility, a replacement battery retail premises, and an aerosol-generating material container or cartridge retail premises.

The information may refer to an aerosol-generating material container or cartridge, and thus may also be considered as being information about a consumable. Such a consumable may be referred to as an SKU or may be referred to or identified using an SKU identifier.

In one set of examples, the further information includes stock information relating to consumables that may be of interest to the user of the non-combustible aerosol provision system. In these examples, the beacon may convey a real-time or near-real-time (in retail terms, such as per minute, per hour or per day) indication of availability of stock for the non-combustible aerosol provision system. Such consumables include, in the present examples, stock of replacement or alternative aerosol-generating material containers or cartridges for the non-combustible aerosol provision system, but may also or alternatively include stock of refill material for a refillable aerosol-generating material container or cartridge used by the non-combustible aerosol provision system, and/or batter replacements of charging availability for the non-combustible aerosol provision system.

In some such implementations, the further information in the beacon provides information about stock of consumables generally, for example indicating that the premises/facility has some stock of consumables for one or more a range of one or more types of non-combustible aerosol provision systems without indicating which types of consumables are in stock. In further implementations, the further information may indicate stock of consumables in the form of indicating the type(s) of non-combustible aerosol provision system for which stock is available. In such examples, the non-combustible aerosol provision system may analyse the received further information so as to be able to recognise whether the stock information is relevant to that particular non-combustible aerosol provision system.

In additional implementations, either the advertisement or a subsequent connectionless message from the non-combustible aerosol provision system as received by the beacon indicates a type of non-combustible aerosol provision system and/or a type of consumable used by the non-combustible aerosol provision system and the further information provided by the beacon is then made specific to the type of non-combustible aerosol provision system or consumable identified to the beacon by the non-combustible aerosol provision system. For instance the facility/premises may have stock of consumables for multiple different non-combustible aerosol provision system types (which may be multiple types from one manufacturer or corresponding to non-combustible aerosol provision systems from multiple different manufacturers), and by using information to tailor the beacon content to the specific non-combustible aerosol provision system type the notification to the user can then be made more relevant to the facts of the situation.

In some examples, the further information may additionally or alternatively include information about a status of the facility/premises with which the beacon is associated. Such status information can include information about whether or not the facility/premises is open for business and/or information about opening times of the facility/premises

Thus, for example, the symbol/logo indicated in the display element 28a in FIG. 5a may, according to the configuration deployed be indicative of any of: proximity to a beacon (where proximity may be a simple indication of generally being in proximity, or an indication of a degree of proximity); proximity to a beacon associated with a particular type of facility/premises, proximity to a beacon associated with a facility/premises having stock of consumables generally; proximity to a beacon associated with a facility/premises having stock of consumables specific to the type of non-combustible aerosol provision system; and proximity to a beacon associated with a facility/premises having a given open/closed status. It will be understood that one or more additional or alternative forms of content display on the display element 28a may be implemented, including different symbols/logos according to the proximity, products/services available, specific consumables available and/or relevance of consumables available. Also or alternatively the display content may be textual/numerical in nature, such as indicating in words the availability of products/services and/or consumables available.

The sending of information to the beacon about the non-combustible aerosol provision system and/or relevant consumables etc may in some examples only be provided by the non-combustible aerosol provision system after the user has given permission for such data to be shared.

Example methods that can be performed by a non-combustible aerosol provision system to achieve this functionality are now further described with reference to FIGS. 5B and 5C.

Starting at step S5-1, the non-combustible aerosol provision system 10a transmits an advertising packet. This may be a standard BLE advertising packet of a type that is conventionally used to advertise the presence of a BLE device as being available for BLE connection/pairing. No particular advertising packet payload is required for the present approach. To provide for high levels of information about nearby beacons to a user of the non-combustible aerosol provision system, the non-combustible aerosol provision system may be configured to repeatedly send such advertising packets without user input at a suitable time interval. On the other hand, it may be appropriate to conserve battery power of the non-combustible aerosol provision system for aerosol generation or other functionalities, such that a user input may be used to trigger either the sending of the advertising packet or the activation of an operation mode in which such advertising packets are sent. Where a user input is required for this functionality, the non-combustible aerosol provision system will include an input element 30.

Responsive to receipt of the BLE advertising packet by the beacon 40, the beacon sends a response packet. The response packet may be either a BLE scan request packet or a BLE connection request packet. The response packet is then received at the non-combustible aerosol provision system 10a at step S5-3. The response packet thus again indicates to the non-combustible aerosol provision system 10a that a beacon is in an active state and within communications range. The response packet of this example includes the further information.

Optionally, as indicated by the dashed lines, the non-combustible aerosol provision system 10a may perform a step to determine a range to the beacon 40 from which the response was received at step S5-3. This determination, as shown at optional step S5-5, includes calculating a range to the device from which the response packet was received (in this example that device being the beacon 40). This range calculation may be based upon a received signal power of the response packet. By knowing the received signal power an approximate value of the distance D can be calculated.

Thus the non-combustible aerosol provision system 10a can display at optional step S5-7 some information using the display element 28a of the non-combustible aerosol provision system 10a to indicate to the user that a beacon is within range. As shown in FIG. 5A this displayed information is in the present example a symbol indicative of a beacon (or a premises/facility with which the beacon is associated) being within range. In other examples this information could be provided by one or more of other symbols, one or more letters, one or more numerals, one or more audible indications and/or one or more haptic indications. If optional step S5-5 was also carried out, the display of information at step S5-7 can be performed to indicate a range to the beacon and/or convey that the beacon is within a distance D corresponding to a threshold proximity. As will be appreciated, the distance information may additionally be processed and displayed in the same manner as described above with reference to FIGS. 3A, 3B, 3C and 3D such as to provide an indication of the approximate range/degree of proximity of the non-combustible aerosol provision system to the beacon.

In addition, the further information discussed above with respect to FIG. 5A may therefore be included as part of a payload space in the response packet.

Although it is explained that the response packet may be a BLE scan packet or a BLE connection request packet (either or both of which may be used as part of a process of establishing a BLE pairing or connection), there is no need for a BLE pair/connection to actually be established to utilise the approaches of the present examples. In other words, the present approaches utilise a connectionless state of Bluetooth/BLE to achieve the described outcomes. It may be the case that such a pairing/connection is required/desired and thus this may optionally be proceeded with in addition to the present method.

In some examples, it may be that multiple packets are needed to convey the further operational information due to the further information being larger than the available payload space of the response packet. In the present examples where the communications occur using BLE, this situation is accommodated by the use of a first response packet in the form of a BLE scan packet, responsive to the receipt of the BLE scan packet the non-combustible aerosol provision system sends a scan response packet to trigger a connection request packet from the other non-combustible aerosol provision system. In this way, the payload space of both the scan request packet and the connection request packet may be utilised to convey the further information without causing a pair/connection status to be established.

After receipt of the response packet at step S5-3, (and before or after the optional steps S5-5 and S5-7, if carried out) the non-combustible aerosol provision system 10a extracts payload information from the response packet to obtain the further information. Thus the non-combustible aerosol provision system 10a displays at step S5-9 the further information using the display element 28a of the non-combustible aerosol provision system 10a. As shown in FIG. 5A this displayed information is in the present example an a symbol or logo indicative of relevance of the beacon content to the non-combustible aerosol provision system 10a. In other examples this information could be provided by one or more of other symbols, one or more letters, one or more numerals, one or more audible indications and/or one or more haptic indications. As will be understood, if the payload information indicates that the premises/facility with which the beacon is associated is of no or low relevance to the user of the non-combustible aerosol provision system 10a (for example if it has no stock of consumables for the non-combustible aerosol provision system 10a), then the display step S5-11 may either be omitted or may provide display content indicating that a low relevance beacon signal has been received (and/or the presence of a low relevance facility/premises within range).

In some examples, the payload information may include an identifier of the premises/facility with which the beacon is associated. Such an identifier can be displayed on the display element 28a of the non-combustible aerosol provision system 10a, and/or provided to a connected device via a transmitter/receiver element 26 of the non-combustible aerosol provision system 10a. Thus the user may be provided with information from which further details of the premises/facility can be obtained, for example using a separate data connection to a connected device to obtain information via the internet. Such information may include for example an address/location of the premises/facility.

A further example method is shown in FIG. 5C, this method corresponding to an implementation where the non-combustible aerosol provision system 10a transmits information identifying the type of non-combustible aerosol provision system and/or consumable used by the non-combustible aerosol provision system.

As shown in this example, the advertisement as transmitted at step S5-21 includes identifying information from which the beacon can identify a type of the non-combustible aerosol provision system 10a and/or a consumable type for the non-combustible aerosol provision system 10a. This information may include any or all of an indication of the non-combustible aerosol provision system type, a compatible consumable type, and a compatible consumable type with desired consumable properties. For example a given non-combustible aerosol provision system type may be compatible with consumables available in varying nicotine concentration levels and/or flavours. The user may therefore select that the identifying information indicates not only the non-combustible aerosol provision system/consumable type but also a flavour, strength and/or other property of the consumable. Thus the user of the non-combustible aerosol provision system may be able to control that a notification, or a certain type of notification is provided corresponding to the desired consumable properties. The advertisement may be a standard BLE advertising packet of a type that is conventionally used to advertise the presence of a BLE device as being available for BLE connection/pairing. The identifying information may be include as payload of the BLE advertising packet.

Responsive to receipt of the BLE advertising packet by the beacon 40, the beacon sends a response packet. The response packet may be either a BLE scan request packet or a BLE connection request packet. The response packet is then received at the non-combustible aerosol provision system 10a at step S5-23. The response packet thus again indicates to the non-combustible aerosol provision system 10a that a beacon is in an active state and within communications range. Moreover, the response packet of this example includes the further information, which further information is tailored by the beacon to the specific identifying information provided in the advertisement.

In the examples of both FIGS. 5A and 5B, the beacon may have more further information (such as stock and other information) available than can be fitted into a single cycle of connectionless packets. In such circumstances, the beacon may use multiple response packet cycles (i.e. as triggered by multiple separate advertising packets from the non-combustible aerosol provision system) to transmit a complete set of further information to the non-combustible aerosol provision system.

Although it is explained that the response packet may be a BLE scan packet or a BLE connection request packet (either or both of which may be used as part of a process of establishing a BLE pairing or connection), there is no need for a BLE pair/connection to actually be established to utilise the approaches of the present examples. In other words, the present approaches utilise a connectionless state of Bluetooth/BLE to achieve the described outcomes.

It may be the case that such a pairing/connection is required/desired and thus this may optionally be proceeded with in addition to the present method.

In some examples, it may be that multiple packets are needed to convey the further operational information due to the further information being larger than the available payload space of the response packet. In the present examples where the communications occur using BLE, this situation is accommodated by the use of a first response packet in the form of a BLE scan packet, responsive to the receipt of the BLE scan packet the non-combustible aerosol provision system sends a scan response packet to trigger a connection request packet from the other non-combustible aerosol provision system. In this way, the payload space of both the scan request packet and the connection request packet may be utilised to convey the further information without causing a pair/connection status to be established.

In some examples, the approach may be varied such that the advertisement does not include the identifying information, and in response to the advertisement the beacon sends a scan request packet which has a payload corresponding to an invitation to the non-combustible aerosol provision system to provide identifying information for the non-combustible aerosol provision system/consumable if desired. The non-combustible aerosol provision system then sends a scan response packet containing a payload including the identifying information, and responsive thereto the beacon sends a connection request packet with the further information included in the payload. If the non-combustible aerosol provision system sends a scan response packet without identifying information, then the method can continue with the beacon sending a connection request packet having generic further information in the payload and then the processing would continue as indicated in steps S5-5 to S5-11 of FIG. 5B.

After receipt of the response packet with the further information, at step S2-25 the non-combustible aerosol provision system 10a extracts payload information from the response packet to obtain the further information. This further information is then analysed to determine the relevance (or otherwise) of the provided further information to the non-combustible aerosol provision system. Thus the non-combustible aerosol provision system 10a displays at step S5-27 the further information using the display element 28a of the non-combustible aerosol provision system 10a. As shown in FIG. 5A this displayed information is in the present example an a symbol or logo indicative of relevance of the beacon content to the non-combustible aerosol provision system 10a. In other examples this information could be provided by one or more of other symbols, one or more letters, one or more numerals, one or more audible indications and/or one or more haptic indications. As will be understood, if the payload information indicates that the premises/facility with which the beacon is associated is of no or low relevance to the user of the non-combustible aerosol provision system 10a (for example if it has no stock of consumables for the non-combustible aerosol provision system 10a), then the display step S5-27 may either be omitted or may provide display content indicating that a low relevance beacon signal has been received (and/or the presence of a low relevance facility/premises within range).

In this example, steps of distance calculation and display may also optionally be performed.

In some examples, the payload information may include an identifier of the premises/facility with which the beacon is associated. Such an identifier can be displayed on the display element 28a of the non-combustible aerosol provision system 10a, and/or provided to a connected device via a transmitter/receiver element 26 of the non-combustible aerosol provision system 10a. Thus the user may be provided with information from which further details of the premises/facility can be obtained, for example using a separate data connection to a connected device to obtain information via the internet. Such information may include for example an address/location of the premises/facility.

As will be appreciated, the methods of FIGS. 5B and 5C overlap and could be performed as a single method with decisions taken to determine which approach to use. For example, the advertisement may include no identifying information (as in step S5-1) and then if the response from the beacon includes details of specific consumable stock, the method would continue with the non-combustible aerosol provision system determining the relevance of the detailed stock information to the non-combustible aerosol provision system and making a display accordingly. On the other hand, if the response from the beacon does not include detailed stock information and/or invites provision of identifying information, then the non-combustible aerosol provision system can provide identifying information to the beacon, and await detailed stock information corresponding to the identifying information in a further response from the beacon. The method would then continue with the non-combustible aerosol provision system determining the relevance of the specific stock to the non-combustible aerosol provision system and making a display accordingly.

Thus there have been described approaches by which a non-combustible aerosol provision system can determine from a beacon within communication range information about a premises or facility associated with the beacon, and display information describing that information to a user of the non-combustible aerosol provision system by the non-combustible aerosol provision system itself. In other words, this approach provides for a user of a non-combustible aerosol provision system to be informed by their non-combustible aerosol provision system operational properties of a nearby premises or facility at which relevant services or consumables may be obtained.

Although the approach illustrated in FIGS. 2A & 2B, and the approach illustrated in FIGS. 3A, 3B, 3C & 3D, and the approach illustrated in FIGS. 4A and 4B have been described separately from the approach illustrated in FIGS. 5A, 5B and 5C, these approaches can be used in combination. Thus, for example, an implementation can be created in which a user's non-combustible aerosol provision system is able to display information about another active non-combustible aerosol provision system as information about a beacon.

In the examples above, the display on the display element 28a is indicated as being a single display of a symbol/text/numbers etc. In some examples, the display element 28a may be configured to display the content over one or more separate display “screens” or pages. For example, an initial display may be made to indicate proximity of another non-combustible aerosol provision system (such as illustrated with reference to FIG. 2A above) and/or a beacon (such as illustrated with reference to FIG. 5A above), and then a user input (received using a input element 30) may be received such as to cause display of a calculated distance (either as a symbolic range such as indicated in FIGS. 3A, 3B and 3C above or a numerical range) and/or further operational information (such as illustrated with reference to FIG. 4A above) and/or information relating to details of a facility/premises associated with a beacon.

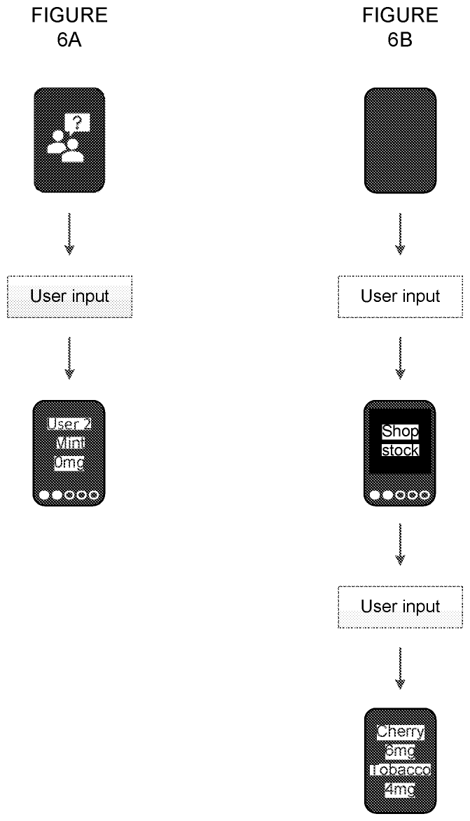

Examples are shown in FIGS. 6A and 6B. In the example of FIG. 6A, the initial display is of a symbol indicative of another non-combustible aerosol provision system being nearby. Responsive to a user input (such as a button press while the initial display is in place, or a predetermined number of shakes/taps while the initial display in in place) the display is updated to include range and further operational information of the non-combustible aerosol provision system of user 2. Although this is indicated as a two-display step approach, in other examples there may be more steps, such as for example if distance and further operational information are set out on separate display steps.

In the example of FIG. 6B a three-display step approach is illustrated, this time for the beacon example. In this example the initial display is of a symbol indicative of a beacon (or beacon-associated premises facility) nearby. Responsive to a user input (such as a button press while the initial display is in place, or a predetermined number of shakes/taps while the initial display in in place) the display is updated to include a description that there is a shop with some consumable stock within a particular distance. Responsive to a further user input, the display is further updated to include a description of specific consumables available at the shop. A selection of which specific consumables to indicate may be made based upon the non-combustible aerosol provision system having stored data indicating particular consumables of interest (such as a list provided by the user and/or a list of previously-inserted consumables). Although this is indicated as a three-display step approach, in other examples there may be fewer or more steps, such as for example if the specific consumables display is omitted or if further specific consumables displays are needed.

A user input may also be used to move to a display of a second other non-combustible aerosol provision system that is also in range. Thus the user may be able to scroll through displays representative of multiple in-range non-combustible aerosol provision systems.

Likewise, a user input may be used to move to a display of a second beacon in range, or to move between an other non-combustible aerosol provision system that is in range and a beacon that is in range. Scrolling through displays of multiple in-range devices (whether another non-combustible aerosol provision system or a beacon) may thus be provided.

Also, different user inputs may be used to move through the displays. For example a first input type (such as a specific duration and/or number of button presses, and/or predetermined number of shakes/taps) may be used to move to information about a presently-displayed other device (e.g. to move through the flow of FIG. 6A or 6B), and a second input type (such as a different specific duration and/or number of button presses, and/or predetermined number of shakes/taps) may be used to move to information about another in-range device (e.g. to move between the flows of FIGS. 6A and 6B, or to move between instances of the flow of 6A to another in-range non-combustible aerosol provision system, or to move between instances of the flow of 6B to another in-range beacon).

Thus there have now been described examples of a multi-screen user interface that may be used to present to the user of an non-combustible aerosol provision system information about another nearby non-combustible aerosol provision system and/or a information provided by a nearby beacon.

As mentioned above, although the detailed examples are set out in terms of communications between a non-combustible aerosol provision system and either another non-combustible aerosol provision system or a beacon being via BLE, other communications technologies may be used in place of BLE for the connectivity technology.

As noted above, BLE is an example of a so-called personal area network technology. Thus another personal area technology may be substituted for BLE with corresponding/equivalent messaging being used to transfer the information between non-combustible aerosol provision systems and/or between a non-combustible aerosol provision system and a beacon. Suitable examples include Bluetooth™, Zigbee™, Wireless USB, and Near-Field Communication (NFC), RFID, Infrared Data association (IrDA), and data-over-sound.

Other connectivity technologies could a wireless network such as a Wi-Fi™ technology. In such a case, it would be assumed that both non-combustible aerosol provision systems or the non-combustible aerosol provision system and beacon are both connected to the same Wi-Fi network (and indeed the beacon could be part of or associated with a Wi-Fi access point through which a non-combustible aerosol provision system may connect to the Wi-Fi network). Thus, without establishing a specific Wi-Fi network between the non-combustible aerosol provision system and the other non-combustible aerosol provision system or beacon, the non-combustible aerosol provision system may be able to advertise its existence on the Wi-Fi network and any other non-combustible aerosol provision system or beacon also connected to the Wi-Fi network would be able to reply with the information indicated in various examples set out above.

Other options for the connectivity technology include a cellular technology such as GSM, GPRS, 2G, 3G, 4G or 5G. Another example is NarrowBand-Interent of Things low power wide area technology. Also, as mentioned above, a wired connectivity technology could be used, such as USB™, a serial port, FireWire™ or other point-to-point wired connectivity.

In addition for any or all of the connectivity technologies mentioned above or earlier, rather than being effectively point-to-point communications between the two non-combustible aerosol provision systems and/or between the non-combustible aerosol provision system and the beacon, the communications could pass through one or more communication hubs or other communications concentrator devices.

Various of the approaches discussed above provide for the user of an non-combustible aerosol provision system to be presented with information about one or more other nearby non-combustible aerosol provision systems by their own non-combustible aerosol provision system itself. In other words, the user of the non-combustible aerosol provision system can receive such information without needing to additionally refer to another device, such as a smartphone or tablet connected to their non-combustible aerosol provision system. Accordingly the user of the non-combustible aerosol provision system can receive such information, for example while having their non-combustible aerosol provision system to hand for making use of aerosol generation functionality. This provides freedom for delivering such information about other nearby non-combustible aerosol provision systems to the user without requiring the user to also have a phone or tablet to hand and connected to their non-combustible aerosol provision system while using (or preparing to use or having recently used) their non-combustible aerosol provision system for aerosol generation.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilised and modifications may be made without departing from the scope of the claimed invention. Various embodiments of the invention may suitably comprise, consist of, or consist essentially of, appropriate combinations of the disclosed elements, components, features, parts, steps, means, etc, other than those specifically described herein. In addition, this disclosure may include other inventions not presently claimed, but which may be claimed in future.

Therefore, from one perspective there has been described a non-combustible aerosol provision system comprising: a wireless communication system configured to receive, from a wireless communication beacon using a connectionless data channel, data relating to a physical location with which the beacon is associated; and a user interface system configured to communicate by a user interface element of the non-combustible aerosol provision system, an indication related to the received data.

Further examples are set out in the following numbered clauses:

Clause 1. A non-combustible aerosol provision system comprising: a data system configured to store operational data relating to an operational state of the non-combustible aerosol provision system and to store received operational data relating to an operational state of another non-combustible aerosol provision system; a wireless communication system configured to receive, from another non-combustible aerosol provision system using a connectionless data channel, operational data relating to an operational state of the another non-combustible aerosol provision system; a user interface system configured to communicate by a user interface element of the non-combustible aerosol provision system, an indication representative of the received operational data relating to an operational state of the another non-combustible aerosol provision system.

Clause 2. The non-combustible aerosol provision system of clause 1, wherein the operational data relating to an operational state of the another non-combustible aerosol provision system comprises one or more selected from the group comprising: information that the another non-combustible aerosol provision system is active; and information identifying a consumable in use by the another non-combustible aerosol provision system.

Clause 3. The non-combustible aerosol provision system of clause 1 or 2, wherein the indication comprises information indicating that the another non-combustible aerosol provision system is within the operational range of the wireless communication system.

Clause 4. The non-combustible aerosol provision system of clause 1, 2 or 3, wherein the indication comprises information indicating that the another non-combustible aerosol provision system is within a particular range of the non-combustible aerosol provision system.

Clause 5. The non-combustible aerosol provision system of any of clauses 1 to 4, wherein the indication comprises information indicating that a other non-combustible aerosol provision system that is within the operational range of the wireless communication system or is within a particular range of the non-combustible aerosol provision system, is the another non-combustible aerosol provision system.

Clause 6. The non-combustible aerosol provision system of any of clauses 1 to 5, further configured to compare the received operational data relating to an operational state of the another non-combustible aerosol provision system to one or more pre-set values, and the user interface system further configured to output one of a plurality of pre-determined outputs depending on the outcome of the comparison.

Clause 7. The non-combustible aerosol provision system of any of clauses 1 to 6, wherein the user interface element comprises one or more selected from the group comprising: a display configured to communicate an indication visually, an audio output device configured to communicate an indication audibly, and a haptic device configured to communicate an indication using touch-detectable motion.

Clause 8. The non-combustible aerosol provision system of any of clauses 1 to 7, wherein the user interface system comprises an input element configured to receive a selection input, and the user interface system is further configured to, responsive to a received selection input, communicate a further indication representative of the received operational data relating to an operational state of the another non-combustible aerosol provision system.

Clause 9. The non-combustible aerosol provision system of clause 8, wherein the input element is a button, pressure-sensitive element, touch membrane of a display, and/or a microphone.

Clause 10. The non-combustible aerosol provision system of any of clauses 1 to 9, wherein the wireless communications system is further configured to send operational data relating to an operational state of the non-combustible aerosol provision system to the another non-combustible aerosol provision system.

Clause 11. The non-combustible aerosol provision system of any of clauses 1 to 10, wherein: the wireless communications system is further configured to receive, from a beacon using a connectionless data channel, data relating to a premises associated with the beacon; and the user interface system is further configured to communicate, by the user interface element, an indication representative of the received data relating to a premises associated with the beacon.

Clause 12. The non-combustible aerosol provision system of any of clauses 1 to 11, wherein the wireless communications system is configured to use a personal area network technology to receive data using the connectionless channel.

Clause 13. The non-combustible aerosol provision system of any of clauses 1 to 12, wherein the connectionless channel is configured to use pre-pairing advertising packets of the personal area network technology.

Clause 14. The non-combustible aerosol provision system of clause 13, wherein pre-pairing advertising packets comprise: an advertising packet transmitted by the non-combustible aerosol provision system; and a request packet and/or a response packet transmitted by the another non-combustible aerosol provision system and subsequently received by the non-combustible aerosol provision system.

Clause 15. The non-combustible aerosol provision system of any of clauses 1 to 14, wherein the wireless communications system is configured to use a wireless network technology to interface to a wireless network, to which both the non-combustible aerosol provision system and the another non-combustible aerosol provision system are connected, and wherein the connectionless channel is configured to use network packets sent over the wireless network to receive the operational data without establishing a network session with the another non-combustible aerosol provision system.

Clause 16. The non-combustible aerosol provision system of any of clauses 1 to 15, wherein the wireless communications system uses a hub-based approach.

Clause 17. A system comprising: a first non-combustible aerosol provision system and a second non-combustible aerosol provision system, the first non-combustible aerosol provision system comprising: a first wireless communication system configured to receive, from the second non-combustible aerosol provision system using a connectionless data channel, operational data relating to an operational state of the second non-combustible aerosol provision system; a first data system configured to store the received operational data relating to an operational state of the second non-combustible aerosol provision system; and a first user interface system configured to communicate by a user interface element of the first non-combustible aerosol provision system, an indication representative of the received operational data relating to an operational state of the second non-combustible aerosol provision system; the second non-combustible aerosol provision system comprising: a second wireless communication system configured to receive, from the first non-combustible aerosol provision system using a connectionless data channel, operational data relating to an operational state of the first non-combustible aerosol provision system; a second data system configured to store the received operational data relating to an operational state of the second non-combustible aerosol provision system; and the second wireless communication system configured to send, to the first non-combustible aerosol provision system using the connectionless data channel, the operational data relating to an operational state of the second non-combustible aerosol provision system.

Clause 18. The system of clause 17, wherein: the first data system is further configured to store operational data relating to an operational state of the first non-combustible aerosol provision system; the first wireless communication system is further configured to send, to the second non-combustible aerosol provision system using the connectionless data channel, the operational data relating to an operational state of the first non-combustible aerosol provision system; the second wireless communication system is further configured to receive, from the first non-combustible aerosol provision system using the connectionless data channel, the operational data relating to an operational state of the first non-combustible aerosol provision system; and wherein the second non-combustible aerosol provision system further comprises a second user interface system configured to communicate by a user interface element of the second non-combustible aerosol provision system, an indication representative of the received operational data relating to an operational state of the first non-combustible aerosol provision system.

Clause 19. The system of clause 17 or 18, wherein the operational data relating to an operational state of the first and/or second non-combustible aerosol provision system and comprises one or more selected from the group comprising: information that the other of the first and second non-combustible aerosol provision systems is active; and information identifying a consumable in use by other of the first and second non-combustible aerosol provision systems.

Clause 20. The system of clause 17, 18 or 19, wherein the indication comprises information indicating that other of the first and second non-combustible aerosol provision systems is within the operational range of the wireless communication system.

Clause 21. The system of any of clauses 17 to 20, wherein the indication comprises information indicating that other of the first and second non-combustible aerosol provision systems is within a particular range of the non-combustible aerosol provision system.

Clause 22. The system of any of clauses 17 to 21, wherein the indication comprises information indicating that other of the first and second non-combustible aerosol provision systems that is within the operational range of the wireless communication system or is within a particular range of the non-combustible aerosol provision system, is the other of the first and second non-combustible aerosol provision systems.

Clause 23. The system of any of clauses 17 to 22, wherein the first non-combustible aerosol provision system is configured to compare the received operational data relating to an operational state of the second non-combustible aerosol provision system to one or more pre-set values, and the first user interface system is configured to output one of a plurality of pre-determined outputs depending on the outcome of the comparison.

Clause 24. The system of clause 18 or any of clauses 19 to 23 when dependent from clause 18, wherein the second non-combustible aerosol provision system is configured to compare the received operational data relating to an operational state of the first non-combustible aerosol provision system to one or more pre-set values, and the second user interface system is configured to output one of a plurality of pre-determined outputs depending on the outcome of the comparison.

Clause 25. The system of any of clauses 18 to 24, wherein the first and/or second user interface element comprises one or more selected from the group comprising: a display configured to communicate an indication visually, an audio output device configured to communicate an indication audibly, and a haptic device configured to communicate an indication using touch-detectable motion.

Clause 26. The system of any of clauses 18 to 25, wherein the first or second user interface system comprises an input element configured to receive a selection input, and the user interface system is further configured to, responsive to a received selection input, communicate a further indication representative of the received operational data relating to an operational state of the other of the first and second non-combustible aerosol provision systems.

Clause 27. The system of clause 26, wherein the input element is a button, pressure-sensitive element, touch membrane of a display, and/or a microphone.

Clause 28. The system of any of clauses 18 to 27, wherein: the first and/or second wireless communications system is further configured to receive, from a beacon using a connectionless data channel, data relating to a premises associated with the beacon; and the first and/or second user interface system is further configured to communicate, by the user interface element, an indication representative of the received data relating to a premises associated with the beacon.

Clause 29. The system of any of clauses 18 to 29, wherein the first and wireless communications systems are configured to use a personal area network technology to receive data using the connectionless channel.

Clause 30. The system of any of clauses 18 to 29, wherein the connectionless channel is configured to use pre-pairing advertising packets of the personal area network technology.

Clause 31. The system of clause 30, wherein pre-pairing advertising packets comprise: an advertising packet transmitted by the first or second non-combustible aerosol provision system; and a request packet and/or a response packet transmitted by the second or first non-combustible aerosol provision system and subsequently received by the first or second non-combustible aerosol provision system.

Clause 32. The system of any of clauses 18 to 31, wherein the wireless communications system is configured to use a wireless network technology to interface to a wireless network, to which both the first and second non-combustible aerosol provision systems are connected, and wherein the connectionless channel is configured to use network packets sent over the wireless network to receive the operational data without establishing a network session with the another non-combustible aerosol provision system.

Clause 33. The system of any of clauses 18 to 32, wherein the wireless communications system uses a hub-based approach.

Clause 34. A method comprising: receiving, by a non-combustible aerosol provision system and from another non-combustible aerosol provision system using a connectionless data channel, operational data relating to an operational state of the another non-combustible aerosol provision system; storing, by the non-combustible aerosol provision system, received operational data relating to an operational state of another non-combustible aerosol provision system; communicating, by the non-combustible aerosol provision system, an indication representative of the received operational data relating to an operational state of the another non-combustible aerosol provision system.

Clause 35. The method of clause 34, wherein the operational data relating to an operational state of the another non-combustible aerosol provision system comprises one or more selected from the group comprising: information that the another non-combustible aerosol provision system is active; and information identifying a consumable in use by the another non-combustible aerosol provision system.

Clause 36. The method of clause 34 or 35, wherein the indication comprises information indicating that the another non-combustible aerosol provision system is within the operational range of a wireless communication system of the non-combustible aerosol provision system.

Clause 37. The method of clause 34, 35 or 36, wherein the indication comprises information indicating that the another non-combustible aerosol provision system is within a particular range of the non-combustible aerosol provision system.

Clause 38. The method of any of clauses 34 to 37, wherein the indication comprises information indicating that an other non-combustible aerosol provision system that is within the operational range of the wireless communication system or is within a particular range of the non-combustible aerosol provision system, is the another non-combustible aerosol provision system.

Clause 39. The method any of clauses 34 to 38, further comprising comparing the received operational data relating to an operational state of the another non-combustible aerosol provision system to one or more pre-set values, and communicating one of a plurality of pre-determined outputs depending on the outcome of the comparing.

Clause 40. The method of any of clauses 34 to 39, wherein the communicating comprises one or more selected from the group comprising: communicating an indication visually, communicating an indication audibly, and communicating an indication using touch-detectable motion.

Clause 41. The method of any of clauses 34 to 40, further comprising receiving a selection input, and responsive to a received selection input, communicating a further indication representative of the received operational data relating to an operational state of the another non-combustible aerosol provision system.

Clause 42. The method of clause 41, wherein the receiving the selection input receives the selection input via a button, pressure-sensitive element, touch membrane of a display, and/or a microphone.

Clause 43. The method of any of clauses 34 to 42, further comprising sending operational data relating to an operational state of the non-combustible aerosol provision system to the another non-combustible aerosol provision system.

Clause 44. The method of any of clauses 34 to 43, further comprising: receiving, from a beacon using a connectionless data channel, data relating to a premises associated with the beacon; and communicating an indication representative of the received data relating to a premises associated with the beacon.

Clause 45. The method of any of clauses 34 to 44, wherein receiving data using the connectionless channel comprises receiving the data using a personal area network technology.

Clause 46. The method of any of clauses 34 to 45, wherein the connectionless channel is configured to use pre-pairing advertising packets of the personal area network technology.

Clause 47. The method of clause 46, wherein pre-pairing advertising packets comprise: an advertising packet transmitted by the non-combustible aerosol provision system; and a request packet and/or a response packet transmitted by the another non-combustible aerosol provision system and subsequently received by the non-combustible aerosol provision system.

Clause 48. The method of any of clauses 34 to 47, wherein a receiving data using the connectionless data channel comprises receiving the data via a wireless network, wherein both the non-combustible aerosol provision system and the another non-combustible aerosol provision system are connected to the wireless network, and wherein receiving the data via the wireless network comprises using network packets sent over the wireless network to receive the operational data without establishing a network session with the another non-combustible aerosol provision system.

Clause 49. The method of any of clauses 34 to 48, wherein the wireless communications system uses a hub-based approach.

1. A non-combustible aerosol provision system comprising:
a wireless communication system configured to receive, from a wireless communication beacon using a connectionless data channel, data relating to a physical location with which the beacon is associated; and
a user interface system configured to communicate by a user interface element of the non-combustible aerosol provision system, an indication related to the received data.

2. The non-combustible aerosol provision system of claim 1, wherein the beacon is located at, in or near the physical location.

3. The non-combustible aerosol provision system of claim 1, wherein the received data comprises information indicating that the beacon associated with the physical location is within the operational range of the wireless communication system or is within a particular range of the non-combustible aerosol provision system.

4. The non-combustible aerosol provision system of claim 1, further configured to compare the received data to one or more pre-set values, and the user interface system further configured to communicate one of a plurality of pre-determined outputs depending on the outcome of the comparison.

5. The non-combustible aerosol provision system of claim 1, wherein the received data comprises data relating to an open/closed status of the physical location.

6. The non-combustible aerosol provision system of claim 5, wherein the data relating to an open/closed status of the physical location comprises one or more of: a present open closed status; and a future open/closed status.

7. The non-combustible aerosol provision system of claim 1, wherein the received data comprises data relating to stock available at the physical location.

8. The non-combustible aerosol provision system of claim 7, wherein the physical location is a retail premises and the data relating to stock available at the physical location is information about types of consumables and/or accessories available at that retail premises.

9. The non-combustible aerosol provision system of claim 7, wherein the user interface system has an input element configured to receive a selection input, responsive to which the user interface system is configured to communicate a further indication representative of the received data relating to stock available at the physical location.

10. The non-combustible aerosol provision system of claim 7, further comprising a processor configured to filter the data relating to stock available at the physical location to remove data relating to stock that is not relevant to the non-combustible aerosol provision system, and wherein the user interface system is configured to communicate the filtered stock information.

11. The non-combustible aerosol provision system of claim 7, wherein the received data relating to stock available at the physical location with which the beacon is associated received in response to sending a first advertising packet from the non-combustible aerosol provision system to the beacon is different to data relating to stock available at the physical location with which the beacon is associated received in response to sending a second advertising packet from the non-combustible aerosol provision system to the beacon.

12. The non-combustible aerosol provision system of claim 1, wherein the wireless communications system uses Bluetooth and/or Bluetooth Low Energy protocols and is configured to send and/or receive data using a connectionless channel.

13. The non-combustible aerosol provision system of claim 1, wherein the connectionless channel comprises using pre-pairing advertising packets.

14. The non-combustible aerosol provision system of claim 13, wherein pre-pairing advertising packets comprise: an advertising packet transmitted by the non-combustible aerosol provision system; and a request packet and/or a response packet transmitted by the beacon and subsequently received by the non-combustible aerosol provision system.

15. The non-combustible aerosol provision system of claim 1, wherein the wireless communications system uses a hub-based approach.

16. The non-combustible aerosol provision system of claim 1, wherein the user interface element comprises one or more selected from a display, an audio output device, and a haptic device.

17. The non-combustible aerosol provision system of claim 1, wherein the user interface system further comprises an input element configured to receive a selection input to select a user interface function.

18. A wireless communication beacon comprising:
a data interface configured to receive data relating to a physical location with which the beacon is associated; and
a wireless communication system configured to transmit using a connectionless data channel, data relating to the physical location with which the beacon is associated.

19-30. (canceled)

31. A system comprising:
a non-combustible aerosol provision system and a wireless beacon,
the wireless beacon comprising:
a data interface configured to receive data relating to a physical location with which the beacon is associated; and
a wireless communication system configured to transmit using a connectionless data channel, data relating to the physical location with which the beacon is associated;
and the non-combustible aerosol provision system comprising:
a wireless communication system configured to receive, from the wireless communication beacon using a connectionless data channel, the data relating to the physical location with which the beacon is associated; and
a user interface system configured to communicate by a user interface element of the non-combustible aerosol provision system, an indication related to the data relating to the physical location with which the beacon is associated.

32-80. (canceled)

81. A method for a system comprising a non-combustible aerosol provision system and a wireless beacon, the method comprising:
receiving, using a data interface of the wireless beacon data relating to a physical location with which the beacon is associated;
transmitting, using a wireless communication system configured to transmit using a connectionless data channel, data relating to the physical location with which the beacon is associated;
receiving, using a wireless communication system configured to receive using the connectionless data channel, the data relating to the physical location with which the beacon is associated; and
communicating, using a user interface system configured to communicate by a user interface element of the non-combustible aerosol provision system, an indication representative of the data relating to the physical location with which the beacon is associated.

82-100. (canceled)
